(19) United States
(12) Patent Application Publication
(10) Pub. No.: US 2013/0122296 A1
(43) Pub. Date: May 16, 2013

(54) Downhole Cables for Well Operations

(71) Applicants: Lawrence C. Rose, Huntsville, TX (US); Michael L. Fripp, Carrollton, TX (US); Jack G. Clemens, Fairview, TX (US); Richard Mineo, Richardson, TX (US); Todd B. Miller, Carrollton, TX (US); Jerry C. Foster, Lewisville, TX (US)

(72) Inventors: Lawrence C. Rose, Huntsville, TX (US); Michael L. Fripp, Carrollton, TX (US); Jack G. Clemens, Fairview, TX (US); Richard Mineo, Richardson, TX (US); Todd B. Miller, Carrollton, TX (US); Jerry C. Foster, Lewisville, TX (US)

(73) Assignee: Halliburton Energy Services, Inc., Houston, TX (US)

(21) Appl. No.: 13/809,501

(22) PCT Filed: Jul. 11, 2011
(86) PCT No.: PCT/US11/43592

§ 371 Date: Jan. 10, 2013

Related U.S. Application Data
(60) Provisional application No. 61/363,276, filed on Jul. 11, 2010.

(51) Int. Cl. H01B 7/17; G02B 6/44; H02G 9/00; B05D 5/00

(52) U.S. Cl. CPC H01B 7/17; B05D 5/00; G02B 6/4401; H02G 9/00
USPC 428/376; 427/256; 427/117; 385/101; 174/70 C; 174/107; 428/375

(57) ABSTRACT

A slickline cable comprises an axially extending strength member having a first diameter proximate an upper end and at least one smaller second diameter distal from the upper end. A coating material is adhered to at least a portion of the length of the strength member to form a substantially uniform outer diameter along the slickline cable. A method for making a slickline comprises forming an axially extending strength member having a first diameter proximate an upper end and at least one smaller second diameter distal from the upper end. A coating material is adhered to at least a portion of the length of the strength member to form a substantially uniform outer diameter along the slickline cable.

### BACKGROUND OF THE INVENTION

The present disclosure relates generally to the field of downhole cables for well operations.

Equipment used in well operations may be deployed into, and retrieved from, a wellbore, also called a borehole, using a cable. As used herein the term cable comprises slickline and wireline cables. Such deployment cables are required to have sufficient pulling capability to support the weight of the tool and the wireline, and to provide sufficient additional pulling force to release itself from the payload at a designed weak point should the equipment become stuck in the hole. In some cases, for example in a deep well, the weight of the cable alone in the wellbore may exceed its safe tension operating limit, providing no margin for releasing from a stuck tool.

### BRIEF DESCRIPTION OF THE DRAWINGS

A better understanding of the present invention can be obtained when the following detailed description of example embodiments are considered in conjunction with the following drawings, in which like elements are indicated by like reference indicators:

FIGS. 1A and 1B show an example of a rig-up for performing down-hole well operations;

FIG. 2 shows an example of a tapered slickline;

FIG. 3 shows an example of a shaped slickline having at least one energy conductor therein;

FIG. 4 shows another example of a shaped slickline having at least one energy conductor therein;

FIG. 5 shows another example of a shaped slickline having at least one energy conductor therein;

FIG. 6 shows another example of a shaped slickline having at least one energy conductor therein;

FIG. 7 shows another example of a shaped slickline having at least one energy conductor therein;

FIG. 8 shows another example of a shaped slickline having at least one energy conductor therein;

FIG. 9 shows another example of a shaped slickline having at least one energy conductor therein;

FIG. 10 shows an example of a tapered wireline having at least one energy conductor therein;

FIG. 11 shows an example of a wireline having shaped armor elements;

FIG. 12 shows another example of a wireline having shaped armor elements;

FIG. 13A-C show examples of cables wherein the cross sectional area of the strength members is reduced along the cable; and

FIG. 14-C show the examples of FIG. 13A-C with an external coating.

While the invention is susceptible to various modifications and alternative forms, specific embodiments thereof are shown by way of example in the drawings and will herein be described in detail. It should be understood, however, that the drawings and detailed description herein are not intended to limit the invention to the particular form disclosed, but on the contrary, the intention is to cover all modifications, equivalents and alternatives falling within the scope of the present invention as defined by the appended claims.

### DETAILED DESCRIPTION

Described below are several illustrative embodiments of the present invention. They are meant as examples and not as limitations on the claims that follow.

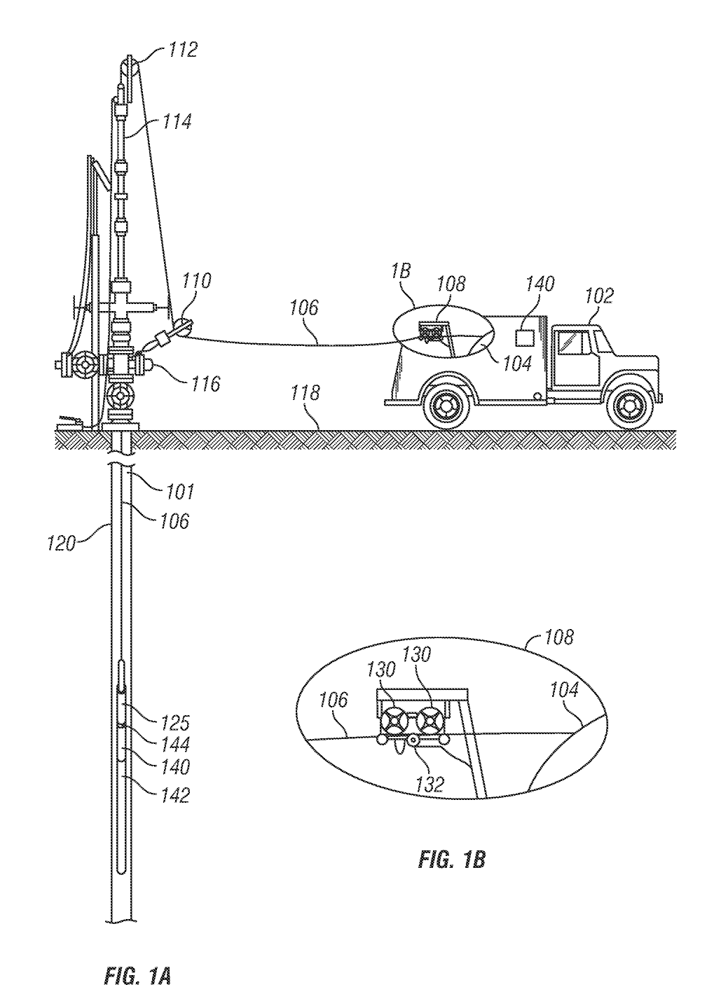

FIGS. 1A and 1B show an example of a rig-up for performing down-hole well operations, also called well services, in a well bore 101. As used herein, well operations comprise logging, fishing, completions, and workover operations. Well services truck 102 may contain a number of different features, for example, for this application, truck 102 contains drum 104, which spools off cable 106 through a combination measuring device/weight indicator 108. Cable 106 is rigged through lower sheave wheel 110 and upper sheave wheel 112, and enters the well bore through pressure control equipment 114, used to contain well bore pressure while allowing cable 106 to move freely in and out of the well bore. Cable 106 enters the well bore at well head connection 116, upon which pressure control equipment is connected. Below surface 118, pipe or casing 120 proceeds to a bottom depth (not shown). Within casing 120 is well tool 125, connected to cable 106.

Combination measuring device weight indicator 108 comprises of at least one, but normally a plurality of measure wheels 130. Measure wheels 130 are precision ground to a precise diameter, and turn proportionally with cable 106 as it goes into and out of the well bore. Measure wheels 130 are mechanically connected to a depth encoder device (not shown) that provides digital signals based on the position of the depth wheel. Thus, as cable 106 moves into and out of the well bore 101, a plurality of depth signals are sent to a data handling system 140 disposed in truck 102 in order to provide the operator with accurate depth data. Additionally, in the example shown, combination measuring device weight indicator 108 contains cable tension wheel 132. Cable tension wheel 132 applies a set amount of pressure against cable 106, in the direction of measure wheels 130. As the amount of cable in the well bore increases, the tension applied by the weight of the cable resists against cable tension wheel 132, causing the load on cable tension wheel 132 to increase toward measure wheels 130. Cable tension wheel 132 is mechanically connected to a load cell, and as the weight of cable 106 increases, causing the load on tension wheel 132 to increase, the load cell sends a signal into the logging compartment of truck 102, indicating an increase in the tension on cable 106.

As used herein the term cable comprises slickline and wireline cables. As used herein, wireline cable comprises braided strength members surrounding a core that contains one or more energy conductors. The energy conductors may comprise electrical conductors, optical fibers, and combinations thereof. The conductors may be configured as single conductors, stranded conductors, coaxial conductors, and combinations thereof. As used herein, slickline cable comprises a single strand strength member having a relatively smooth outer surface. While the slickline strength member may be metallic, it is not used to conduct electrical signals or power. Generally, a slickline cable does not contain an energy conductor.

### Tapered Slickline

Slickline may be used to convey memory instruments and mechanical devices into wells. It may also provide mechanical services such as shifting sleeves, removing plugs, bailing, and cleaning. The wire must be able to convey the equipment as well as supply a mechanical force transmission to the downhole tools. A limitation of current slickline design is the strength to weight ratio. This limits the depths that the cable can safely deliver payloads and perform mechanical work at the target depths. Due to the weight of the material used to make the wire, the further the wire goes into the well the heavier it gets and the more load the wire at the top of the well must carry. In addition, in deviated wells, the drag of the wire along the side of the wellbore adds to the problem, and the wire no longer has the ability to convey the tools or instruments that it is intended to be used for. The maximum depth that the line can achieve is lower than the line itself can reach due to the tools or payload. The payload is generally larger in OD than the wire. If the slickline operation becomes stuck in the hole it is generally at the payload since this is the largest OD. And because this is the case the slickline needs to be designed to pull out of the payload with a weak point or other means. But at a certain depth there is no safety factor for this weak point. So, the maximum safely achievable depth is actually lower than the depth that the wire itself can achieve.

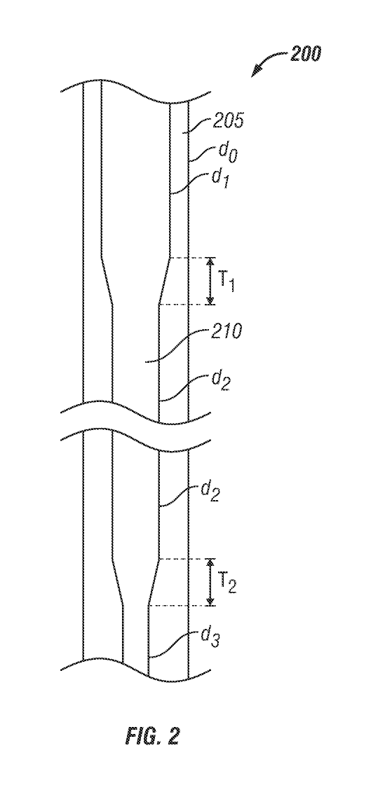

In one embodiment of the present disclosure, see FIG. 2, a tapered slickline 200 is shown. Tapered slickline comprises a strength member 210 that is tapered from a larger diameter d₁ near the surface and at least one smaller diameter d₂, d₃ near the bottom of the well. Such a cable is lighter at the bottom and heavier and larger at the top where the larger pull capacity is required. The tapered slickline may be drawn in multiple diameters over the length of the slickline. The length of the taper sections T₁, T₂ may vary from a few inches to several hundred feet. Any number of diameters and taper sections may be used.

As one skilled in the art will appreciate, common surface pressure control equipment 114 (see FIG. 1), may be designed to work with a substantially constant diameter slickline. In one example embodiment, a coating material 205 is adhered to the wire such that the coating material diameter d₀ is compatible with pressure control equipment 114. In one example, the coating material 205 may be applied over the length of the strength member 210. In another example, the coating material 205 may be applied over just the smaller diameters d₂, d₃, and blend with the largest strength member diameter d₁. In this example, d₁ would be chosen to match the diameter required for the pressure control equipment 114. The appropriate coating may be chosen based on suitable operational factors including, but not limited to, surface pressure, downhole pressure, downhole temperature, depth of the work, overpull requirements, downhole fluid corrosion properties, and friction factors. In one example, where economically feasible, the slickline coating and diameter selection may be selected for a specific location.

Non-limiting examples of coating materials include polyolefins, polytetrafluoroethylene-perfluoromethylvinylether polymer (MFA), perfluoro-alkoxyalkane polymer (PFA), polytetrafluoroethylene polymers (PTFE), ethylene-tetrafluoroethylene polymers (ETFE), ethylene-propylene copolymers (EPC), poly(4-methyl-1-pentene), other fluoropolymers, polyaryletherether ketone polymers (PEEK), polyphenylene sulfide polymers (PPS), modified polyphenylene sulfide polymers, polyether ketone polymers (PEK), maleic anhydride modified polymers, perfluoroalkoxy polymers, fluorinated ethylene propylene polymers, polyvinylidene fluoride polymers (PVDF), polytetrafluoroethylene-perfluoromethylvinylether polymers, polyamide polymers, polyurethane, thermoplastic polyurethane, ethylene chloro-trifluoroethylene polymers, chlorinated ethylene propylene polymers, self-reinforcing polymers based on a substituted poly(1,4-phenylene) structure where each phenylene ring has a substituent R group derived from a wide variety of organic groups, or the like, and any mixtures thereof.

In one example, the coating may be selected with a specific gravity less than the borehole fluid to provide a buoyant lift to the lower portions of the cable. This may reduce parasitic weight from the lower portion of the cable. Balancing buoyancy and friction could reduce not only the weight, but also the drag. In one example a coating material is chosen based on its swelling characteristics in the presence of wellbore fluids, which may improve the buoyancy.

In another example, a slickline material may be selected with an enhanced strength to weight ratio. For example, titanium may be used as the material for the strength member to provide a strength member that is almost as strong as steel, but much lighter. In another example, corrosion resistant materials may be used including, but not limited to: MP35-N, 27-7 MO, 25-6 MO, and 31 MO.

In some embodiments, the coating material may not have sufficient mechanical properties to withstand high pull or compressive forces as the cable is pulled, for example, over sheaves, and as such, may further include short fibers. While any suitable fibers may be used to provide properties sufficient to withstand such forces, examples include, but are not necessarily limited to, carbon fibers, fiberglass, ceramic fibers, aramid fibers, liquid crystal aromatic polymer fibers, quartz, nanocarbon, or any other suitable material.

### Shaped Smart Slickline

A disadvantage of common slickline systems is the lack of a real time power/telemetry system. A real-time power and telemetry system would allow for the real time collection of data and the assurances that the data is valid. It also would allow for the real time visual interpretation of the data to make quicker decisions. By changing the shape of the slickline it is possible to allow the introduction of energy conductors into the strength member of the slickline which would enable slickline to perform like a wireline. If the slickline conductor(s) is large enough to convey power to a downhole tractor then the slickline service may be able to operate in horizontal wells.

Previous attempts at commercializing a smart slickline have met limited success. The original attempt was to put a conductor inside a tube. This hybrid served to combine the problems of wireline and slickline. The problem was that the conductor was undersized and could deliver only limited power and the tube wall was undersized and could be used only in logging type operations due to the limited pull capabilities, which eliminated its use in slickline operations.

Other attempts have been made to use the slickline itself by coating the slickline. However this severely limits the power and telemetry but does allow some limited slickline functions. The reliability of coated slickline is problematic, especially on deeper and more deviated wells.

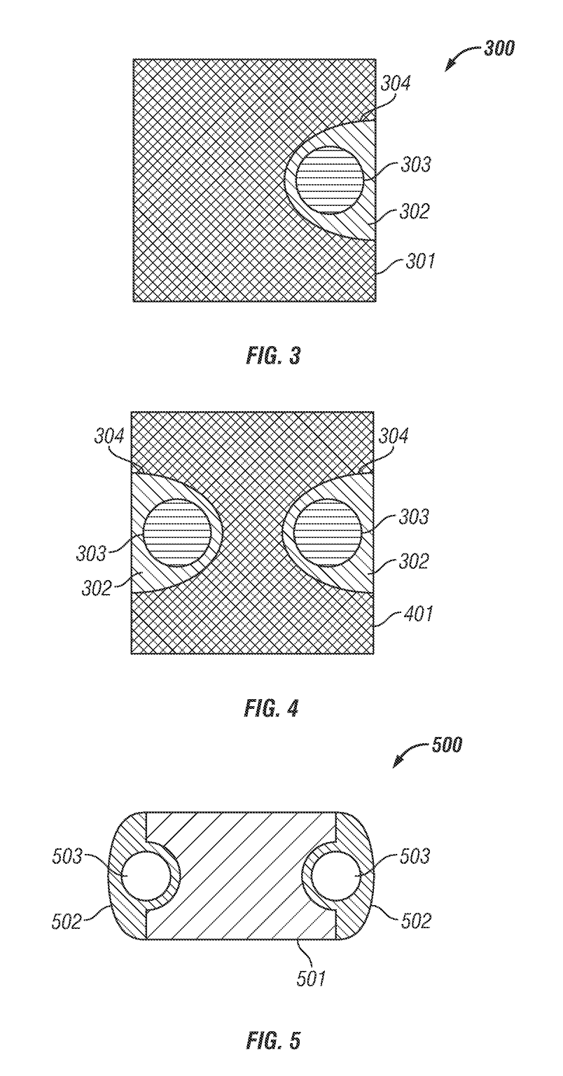

In one embodiment, see FIG. 3, a shaped slickline assembly 300 comprises a shaped strength element 301 having an energy conductor 303 disposed in an axially extending channel formed in the shaped strength element. By changing the shape of the slickline strength element from a round exterior, there are many shapes that can be developed that will allow the installation of one or more energy conductors therein. As indicated previously, the energy conductor may comprise electrical conductors, optical fibers, and combinations thereof. Energy conductors used herein may be bare energy conductors, or alternatively may have protective sheaths. Such conductors, both electrical and optical, are commercially available, and are not described here in detail.

In the example shown in FIG. 3, by changing the shape of strength member 301 from a round exterior to a square, channel 304 may be formed along the side of the square to allow energy conductor 303 to be manufactured into strength member 301. Energy conductor 303 may be fastened in channel 304 by a fastening material, for example, an epoxy and/or a thermoplastic material 302. Suitable thermoplastic materials include, but are not limited to, polyolefins, polytetrafluoroethylene-perfluoromethylvinylether polymer (MFA), perfluoro-alkoxyalkane polymer (PFA), polytetrafluoroethylene polymers (PTFE), ethylene-tetrafluoroethylene polymers (ETFE), ethylene-propylene copolymers (EPC), poly(4-methyl-1-pentene), other fluoropolymers, polyaryletherether ketone polymers (PEEK), polyphenylene sulfide polymers (PPS), modified polyphenylene sulfide polymers, polyether ketone polymers (PEK), maleic anhydride modified polymers, perfluoroalkoxy polymers, fluorinated ethylene propylene polymers, polytetrafluoroethylene-perfluoromethylvinylether polymers, polyvinylidene fluoride polymers (PVDF), polyamide polymers, polyurethane, thermoplastic polyurethane, ethylene chloro-trifluoroethylene polymers, chlorinated ethylene propylene polymers, self-reinforcing polymers based on a substituted poly(1,4-phenylene) structure where each phenylene ring has a substituent R group derived from a wide variety of organic groups, or the like, and any mixtures thereof. Fiber reinforcement can be added to the adhesive to increase the bond strength and to minimize the potential for the bond to be extruded from the wire as it is passed through the lubricator. Suitable fibers may include, but are not limited to, carbon fibers, fiberglass, ceramic fibers, aramid fibers, liquid crystal aromatic polymer fibers, quartz, nanocarbon, or any other suitable material.

In another example embodiment, see FIG. 4, channels 304 are formed on opposite sides of strength member 401 providing two channels for energy conductors 303. Energy conductors 303 may be the same, or different, in slickline assembly 400.

In yet another example, see FIG. 5, slickline assembly 500 comprises a strength conductor 501 having a substantially rectangular shape. Energy conductors 503 and fastening material 502 are similar to those described previously.

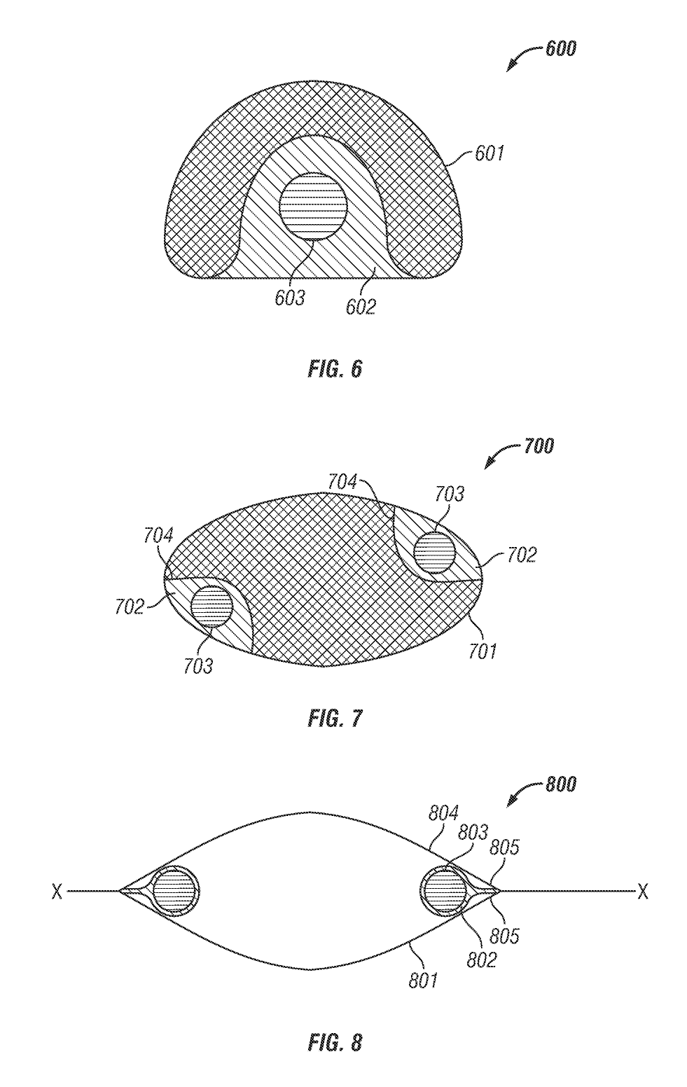

In still another embodiment, see FIG. 6, a single conductor slickline assembly 600 comprises a strength member 601 having an arc shape. Energy conductor 603 and fastening material 602 are similar to those described previously.

In another embodiment, see FIG. 7, slickline assembly 700 may be manufactured in an oblong, also called oval, or “football”, shape. This shape may allow for an easier packoff on the slickline assembly at the pressure control equipment. This would allow grooves for one or more energy conductors 703 to be installed in channels 704. The energy conductors 703 may be fixed in the grooves by fastening material 702.

In another example, see FIG. 8, the football shape may allow the channels 804 to have spring loaded retaining lips 805, so that the energy conductors 803 are retained in channels 804. The energy conductors 803 are located along an axis x-x of the slickline assembly 800 which will minimize the stresses experienced by the conductors 803 when the slickline is bent about the axis x-x.

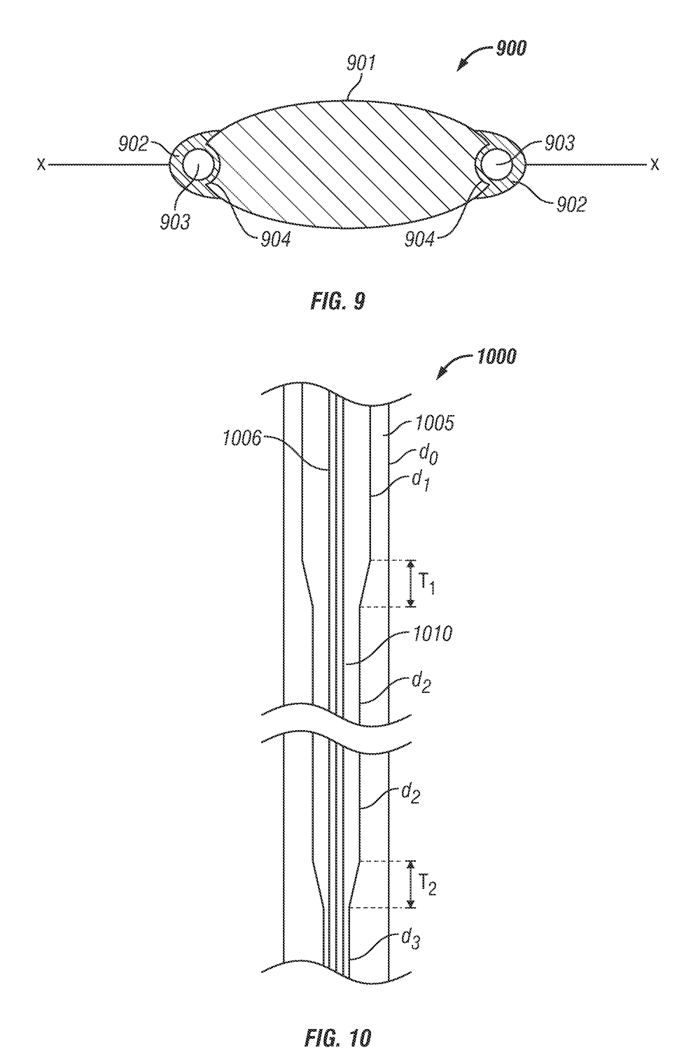

FIG. 9 shows another example of an oblong shaped slickline assembly 900 having a strength member 901 having at least on channel 904 at each end of the major axis x-x. Energy conductors 903 are retained in the channels by fastening material 902 similar to those described previously.

It is noted that the shaped slickline assemblies described above that comprise energy conductors may be used without energy conductors, as well. In addition, the slickline assemblies with, or without, energy conductors may also be tapered as described previously herein. A tapered, non-circular shaped, slickline assembly, as described, may also comprise an external coating, as described previously, such that the outer shape and outer cross section area of the cable remains substantially constant over the length of the cable. In one embodiment, the coating material and the adhesive material may be the same material. In another embodiment, the coating material and the adhesive material may be different.

### Deep Wireline

Current technology for wireline cables used in downhole applications have limitations that cannot be overcome with the current designs. Wireline is used to convey instruments, explosives and mechanical devices into wells. The wireline must be able to convey the equipment as well as supply a means for data and power transmission. One of the limitations to the current wireline design is the strength to weight ratio. This limits the depths that the wireline cable can safely deliver payloads and perform mechanical work at the target depths. Due to the weight of the material used to make the armor wires the further the wireline goes into the well the heavier it gets and the more load the wireline at the top of the well must carry.

A second limitation to the current wireline cable design is that the cables exterior surface, as with any standard braided cable design, is not smooth due to the fact that all of the armor wires are round. This makes it hard to form a seal around the wireline as it enters the well head in wells with pressure. In gas wells, obtaining a seal is even more difficult. This limits the OD of the cable that can be utilized under pressure because the larger the OD of the wireline the larger the OD of the outer armor wires, which creates larger interior and exterior void spaces. Therefore the strength of the wireline that can be run will be limited by the sealing ability of the pressure equipment utilized to enforce a seal around the wireline and contain the pressure within the well. The braided design also brings about environmental concerns when pressure control is required due to the loss of grease used to form the seal around the wireline.

Another limitation due to the exterior of a standard braided cable design is that it adds friction with contact with the sides of the well bore further reducing the depths achievable. This same friction can cause wear to the inside of the completion equipment, which can be very costly for a customer to repair.

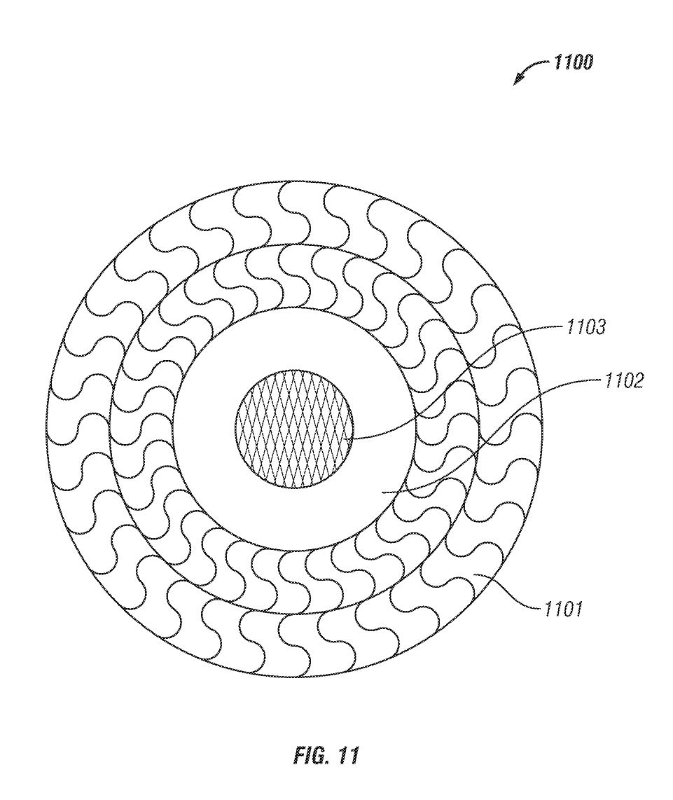

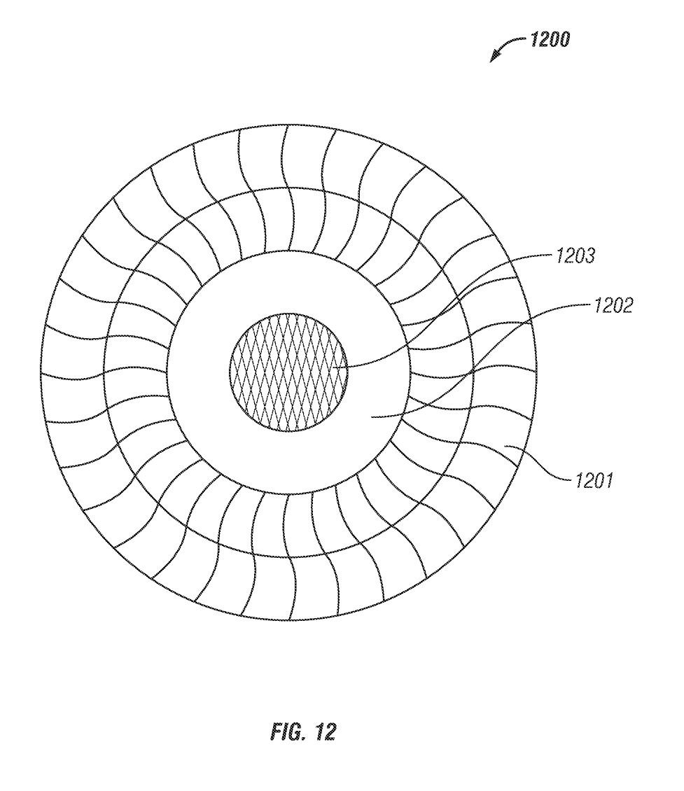

In one embodiment, see FIG. 10, the present disclosure incorporates a smooth single OD exterior, which reduces problems with pressure control and can provide a reduced friction when the wireline comes into contact with the side of the well bore, which will aid in running in and out of the well and will also reduce damage to the completion equipment in the well. A tapered embodiment in the deepest descending portions of the wireline can be made lighter and, in some conditions, neutrally or positively, buoyant.

In one embodiment, see FIG. 10, a tapered wireline 1000 is shown. Tapered wireline comprises one or more energy conductors 1006 that may be electrical and/or optical energy conductors. Helically braided around the energy conductors, are a plurality of armor wire strength members 1010. Multiple layers of strength members 1010 may be used. Strength members 1010 may be a steel material. Alternatively, strength members 1010 may be of a titanium material. In another example, corrosion resistant materials may be used including, but not limited to: MP35-N, 27-7 MO, 25-6 MO, and 31 MO. In the embodiment shown, strength members 1010 may each be tapered over at least a portion of their length, T₁, such that the outer diameter, d₁, of the braid of wound strength members 1010 is larger near the upper end at the surface, and tapers to at least one smaller diameter d₂, d₃ near the bottom of the well. Such a cable is lighter at the bottom and heavier and larger at the top where the larger pull capacity is required. The tapered wireline may be drawn in multiple diameters over the length of the wireline. The length of the taper sections T₁, T₂ may vary from a few inches to several hundred feet. Any number of diameters and taper sections may be used.

In one embodiment, the tapered wireline may be constructed by splicing different size cables together. In another embodiment, the armor wire strength members 1010 may be drawn in different tapering diameters over the length of each strength member 1010. The length, T₁, T₂, over which the strength member diameter is changed, may be several inches to several hundred feet.

In another embodiment, the wireline could be constructed with a first number of layers of armor wire strength members at the top, or largest diameter, and a second number of layers of armor wire strength members at a lower location to create a smaller cable OD.

In yet another embodiment the upper section of the wireline cable, may comprise a first number of armor wire strength members. A lower section may comprise a smaller second number of armor wire strength members thereby reducing the OD of the wireline cable. Additional reductions in cable OD may be obtained by again reducing the number of armor wire strength members. In even another embodiment, larger wire strength members may be used at a first upper section of the wireline cable. A like number of smaller diameter strength members may be used at a second lower section to reduce the OD of the cable. In yet even another embodiment, combinations of the above techniques may be employed, for example combining at least two of: different number of strength member layers at different locations along the cable; different number of strength members at different locations along the cable; and different strength member diameters at different locations along the cable. In one embodiment the different strength member diameters at different locations along the cable may comprise different fixed diameters at different locations and/or tapering diameters along the cable.

As one skilled in the art will appreciate, common surface pressure control equipment 114 (see FIG. 1), may be designed to work with a substantially constant diameter wireline. In one example embodiment, a coating material 1005 is adhered to the wire strength members such that the coating material diameter d₀ is substantially constant to ensure compatibility with pressure control equipment 114. In one example, the coating material 1005 may be applied over the length of the strength member 1010. In another example, the coating material 1005 may be applied over just the smaller diameters d₂, d₃, and blend with the largest strength member diameter d₁. In this example, d₁ would be chosen to match the diameter required for the pressure control equipment 114. The appropriate coating may be chosen based on suitable operational factors including, but not limited to, surface pressure, downhole pressure, downhole temperature, depth of the work, overpull requirements, downhole fluid corrosion properties, and friction factors. In one example, where economically feasible, the wireline coating and outer diameter selection may be selected for the conditions at a specific location.

Non-limiting examples of coating materials include polyolefins, polytetrafluoroethylene-perfluoromethylvinylether polymer (MFA), perfluoro-alkoxyalkane polymer (PFA), polytetrafluoroethylene polymers (PTFE), ethylene-tetrafluoroethylene polymers (ETFE), ethylene-propylene copolymers (EPC), poly(4-methyl-1-pentene), other fluoropolymers, polyaryletherether ketone polymers (PEEK), polyphenylene sulfide polymers (PPS), modified polyphenylene sulfide polymers, polyether ketone polymers (PEK), maleic anhydride modified polymers, perfluoroalkoxy polymers, fluorinated ethylene propylene polymers, polytetrafluoroethylene-perfluoromethylvinylether polymers, polyvinylidene fluoride polymers (PVDF), polyamide polymers, polyurethane, thermoplastic polyurethane, ethylene chloro-trifluoroethylene polymers, chlorinated ethylene propylene polymers, self-reinforcing polymers based on a substituted poly(1,4-phenylene) structure where each phenylene ring has a substituent R group derived from a wide variety of organic groups, or the like, and any mixtures thereof.

In one example, the coating is selected with a material with a specific gravity less than that of the borehole fluid to provide a buoyant lift to the lower portions of the cable. In one example, hollow glass beads may be mixed with the coating to increase the buoyancy. One example is 3M Glass Bubbles supplied by 3M Corporation, St. Paul, Minn. This may reduce parasitic weight from the lower portion of the cable. Balancing buoyancy and friction could reduce not only the weight, but also the drag.

In one example a coating material may be chosen that swells in the presence of downhole fluids, which may improve the buoyancy. In another example, a wireline material may be selected with an enhanced strength to weight ratio. For example, titanium may be used as the material for the strength member to provide a strength member that is almost as strong as steel, but much lighter. In another example, corrosion resistant materials may be used including, but not limited to: MP35-N, 27-7 MO, 25-6 MO, and 31 MO.

In some embodiments, the coating material may not have sufficient mechanical properties to withstand high pull or compressive forces as the cable is pulled, for example, over sheaves, and as such, may further include short fibers. While any suitable fibers may be used to provide properties sufficient to withstand such forces, examples include, but are not necessarily limited to, carbon fibers, fiberglass, ceramic fibers, aramid fibers, liquid crystal aromatic polymer fibers, quartz, nanocarbon, or any other suitable material.

In another embodiment, see FIGS. 11 and 12, the strength members 1101 and 1201 are shaped. Strength members 1101 and 1201 surround at least one energy conductor 1103 and 1203, respectively. In addition, insulator 1102 and 1202 are encased within strength members 1101 and 1201, respectively. In this way the wireline can be made smaller in outside diameter (OD) with the same metal mass. This would enable more strength with a smaller OD, and provide more pulling power while reducing the limitations imposed by the pressure control equipment.

The wireline may be designed with a shaped interior and exterior armor, which when assembled will provide a nearly smooth outer surface. The shape may be such that when the armors are laid together to form the armor, the exterior surface is nearly smooth. The shaping of the armor could take any one of several different forms. These could for example be a serpentine like “flex” design that forms an S shape, see FIG. 11. They could also take on a “curved” disk shape, see FIG. 12. There are any number of shapes that could be formed to create a nearly smooth round exterior once the cable is assembled. The shaping of the armor may be done during pulling of the wire to size by pulling the wire through a shaper. It may also be done in a fashion that would be designed for nano technology where the wires are shaved to increase the alignment of the metal crystals and improve the metal characteristics and strength resulting in a stronger wireline. In addition, the armor shapes may be tapered along their length. When tapered, the outside diameter may be coated with coatings similar to those of the previously described tapered cables, in order to ensure a substantially constant outer diameter of the cable.

Due to the double helix design of the wireline, the direction of the shapes of the inner armor wires may be in the opposite direction of the outer wire armor shapes.

Although it is not a requirement for the inner armors to be shaped, doing so may be beneficial in helping reduce the void space during pressure control operations. These embodiments may be used on any conductors (including coaxial conductors) and optical fibers. This includes multi-conductor cables for example seven conductor cables, crush resistant seven conductor packages enclosed in a jacket material, single conductor, single optical fiber, multiple optical fibers, and combinations thereof.

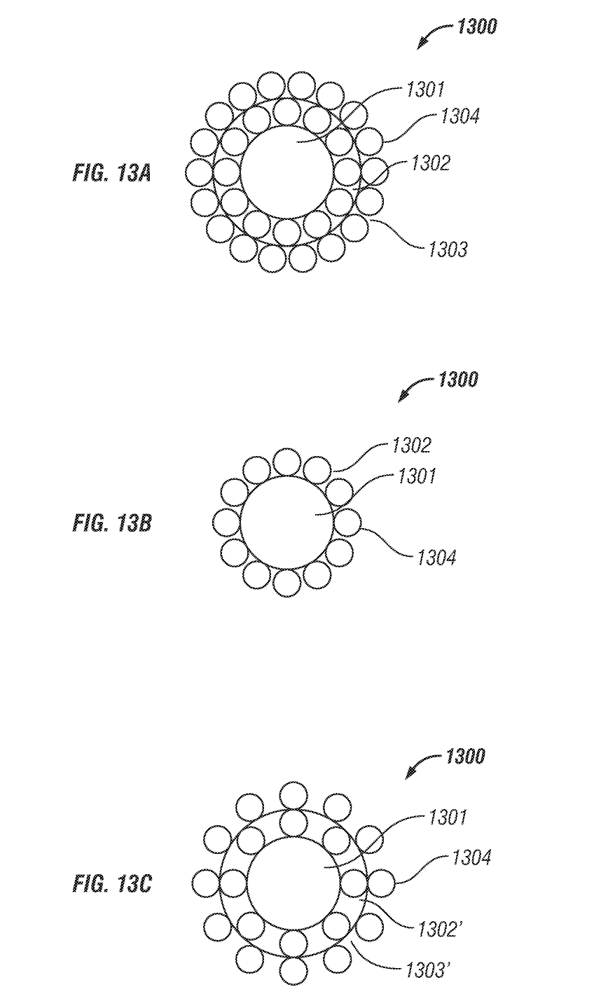

The unit weight of a wireline cable, for example lbs/ft, may be reduced at lower portions by reducing the unit weight of the strength members at the lower portions of the cable. One skilled in the art will appreciate that the unit weight of the strength members is directly proportional to the density of the strength member material and the cross sectional area of the strength members at a location along the cable. By reducing the total cross sectional area of the strength members at a lower location with respect to an upper location, and assuming a substantially constant material density, the unit weight of the cable will be proportionately lighter at the lower location. The technique of tapering the strength members, described above, is one way to accomplish this reduction. FIG. 13A-C show other embodiments wherein the total cross sectional area of the strength members of the cable may be reduced at lower locations. FIG. 13A shows an upper end of cable 1300 having an inner layer 1302 and an outer layer 1303 of armor wire strength members 1304. The strength members 1304 are wrapped around energy conductor 1301. As described previously, energy conductor 1301 may be one or more optical and/or electrical energy conductors known in the art. Armor wire strength members may be any of those described previously, herein. FIG. 13B shows one example of a portion of a lower end of cable 1300 that has only one layer 1302 of armor wire strength members 1304. The cross sectional area of the single layer 1302 is clearly less than that of the double layer of FIG. 13A, with a corresponding decrease in the unit weight of the lower section of cable 1300 compared to the upper section. FIG. 13C depicts another example of a lower end of cable 1300. As shown, the lower end has two modified layers 1302′ and 1303′ as compared to the upper end of FIG. 13A. As shown, there are fewer armor wire strength members 1304 in layers 1302′ and 1303′, as compared to layers 1302 and 1303 of FIG. 13A. The reduced number of armor wire strength members corresponds to a reduced cross sectional area of the strength members at the lower end as compared to the upper end, with a corresponding reduction in cable unit weight at the lower end. In yet another example embodiment, combinations of the cross sectional area/weight reduction techniques may be used. For example, in one transition, the number of layers may remain the same with a reduction in the number of strength members. An additional reduction in another section may comprise a reduction of the number of layers. While cable 1300 is shown with two layers, any number of layers may be used.

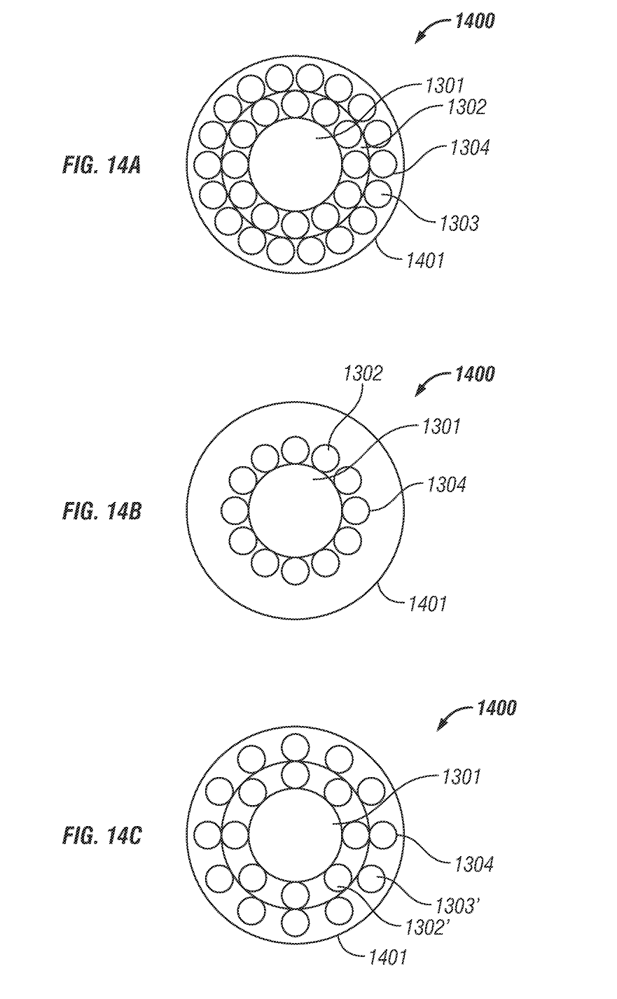

FIG. 14A-C show similar cables to those of FIG. 13A-C, but having a coating 1401, for example, any of the coatings as described previously herein, adhered to the armor wire strength members to provide a smooth exterior diameter. In one embodiment, the exterior diameter is substantially constant along the length of the cable. In another embodiment, the coating 1401 may be adhere to only a portion of the length of cable 1300.

Numerous variations and modifications will become apparent to those skilled in the art. It is intended that the following claims be interpreted to embrace all such variations and modifications.

We claim:

1. A slickline cable comprising:
an axially extending strength member having a first diameter proximate an upper end and at least one smaller second diameter distal from the upper end; and
a coating material adhered to at least a portion of the length of the strength member to form a substantially uniform outer diameter along the slickline cable.

2. The slickline cable of claim 1 wherein the substantially uniform outer diameter of the slickline cable is chosen from the group consisting of: the first diameter; and a predetermined diameter larger than the first diameter.

3. The slickline cable of claim 2 wherein the coating comprises a thermoplastic material.

4. The slickline cable of claim 1 wherein the coating has a specific gravity less than a specific gravity of a fluid in a wellbore.

5. The slickline cable of claim 1 wherein the coating material swells when exposed to a slickline fluid.

6. The slickline cable of claim 1 wherein the coating comprises at least on of: a plurality of reinforcing fibers and a plurality of hollow glass beads.

7. The slickline cable of claim 1 wherein the strength member continuously tapers from the first diameter to the at least one second diameter.

8. The slickline cable of claim 1 wherein the at least one second diameter comprises a plurality of monotonically decreasing diameters from the upper end to a lower end of the cable.

9. The slickline cable of claim 1 further comprising at least one axially extending channel in an outer surface of the strength member, and at least one axially extending energy conductor disposed in the at least one axially extending channel.

10. A slickline cable comprising:
a strength member having at least one axially extending channel formed in an outer surface of the strength member wherein at least a portion of the cross section of the strength member is non-circular; and
at least one axially extending energy conductor disposed in the at least one axially extending channel.

11. The slickline cable of claim 10 further comprising a fastening material to fasten the at least one energy conductor in the at least one axially extending channel.

12. The slickline cable of claim 10 wherein the at least one energy conductor is chosen from the group consisting of: an optical conductor, an electrical conductor, and combinations thereof.

13. The slickline cable of claim 10 wherein the strength member has a shape chosen from the group consisting of: a square shape, a rectangular shape, an arcuate shape; an oval shape, and combinations thereof.

14. The slickline cable of claim 10 wherein the strength member has a first cross section area proximate an upper end and at least one smaller second cross section area distal from the upper end.

15. The slickline cable of claim 13 further comprising a coating material adhered to at least a portion of the length of the strength member to form a substantially constant outer shape and a substantially constant outer cable cross section area along the slickline cable length.

16. A wireline cable comprising:
at least one energy conductor; and
at least one plurality of armor wire strength members braided around the at least one energy conductor, the at least one plurality of armor wire strength members having a first total cross sectional area proximate an upper end of the wireline cable and at least one smaller second total cross sectional area distal from the upper end.

17. The wireline cable of claim 16 further comprising a coating material adhered to at least a portion of the length of cable to form a substantially smooth uniform outer diameter of the wireline cable along the coated portion of the cable.

18. The wireline cable of claim 17 wherein the coating comprises a thermoplastic material.

19. The wireline cable of claim 16 wherein the coating has a specific gravity less than a specific gravity of a fluid in a wellbore.

20. The tapered wireline cable of claim 16 wherein the coating material swells when exposed to a wellbore fluid.

21. The wireline cable of claim 16 wherein the coating comprises at least one of: is fiber reinforced.

22. The wireline cable of claim 16 wherein the at least one plurality of armor wire strength members comprises a first predetermined number of layers of armor wire strength members resulting in the first total cross sectional area and a second smaller predetermined number of layers of armor wire strength members resulting in the smaller second total cross sectional area.

23. The wireline cable of claim 16 wherein the at least one plurality of armor wire strength members comprises a first predetermined number of armor wire strength members in the first total cross sectional area and a smaller second predetermined number of armor wire strength members resulting in the smaller second total cross sectional area.

24. The wire line cable of claim 16 wherein the at least one plurality of armor wire strength members comprise a predetermined number of armor wire strength members that are tapered over at least a portion of their length such they that result in the first total cross sectional area proximate their upper end and the smaller second cross sectional area distal from their upper end.

25. The wireline cable of claim 16, wherein at least some of the at least one plurality of armor wire strength members comprise non-circular and non-rectangular cross sectional shapes.

26. The wireline cable of claim 25 wherein the non-circular and non-rectangular cross sectional shapes comprise at least one of: an S shape, and a curved disk shape.

27. The wireline cable of claim 19 wherein the coating material comprises hollow glass beads.

28. A method for making a slickline comprising:
forming an axially extending strength member having a first diameter proximate an upper end and at least one smaller second diameter distal from the upper end; and
adhering a coating material to at least a portion of the length of the strength member to form a substantially uniform outer diameter along the slickline cable.

29. The method of claim 28 wherein the coating comprises a thermoplastic material.

30. The method claim 28 wherein the coating has a specific gravity less than a specific gravity of a fluid in a wellbore.

31. The method of claim 28 wherein the coating material swells when exposed to a slickline fluid.

32. The method of claim 28 further comprising mixing at least one of, a plurality of reinforcing fibers, and a plurality of hollow glass beads, in the coating.

33. The method of claim 28 further comprising continuously tapering the strength member from the first diameter to the at least one second diameter.

34. The method of claim 28 wherein the at least one second diameter comprises a plurality of monotonically decreasing diameters from the upper end to a lower end of the cable.

35. The method of claim 28 further comprising forming at least one axially extending channel in an outer surface of the strength member, and disposing at least one axially extending energy conductor in the at least one axially extending channel.

36. A method for making a wireline cable comprising:
forming at least one plurality of armor wire strength members around at least one energy conductor, the at least one plurality of armor wire strength members having a first total cross sectional area proximate an upper end of the wireline cable and at least one smaller second total cross sectional area distal from the upper end.

37. The method of claim 36 further comprising adhering a coating material to the length of the cable to form a substantially smooth uniform outer diameter of the wireline cable.

38. The method of claim 37 wherein the coating comprises a thermoplastic material.

39. The method of claim 37 wherein the coating has a specific gravity less than a specific gravity of a fluid in a wellbore.

40. The method cable of claim 36 wherein the coating material swells when exposed to a wellbore fluid.

41. The method of claim 37 further comprising mixing at least one of, a plurality of reinforcing fibers, and a plurality of hollow glass beads, in the coating.

42. The method of claim 36, wherein at least some of the at least one plurality of armor wire strength members comprise non-circular and non-rectangular cross sectional shapes.

43. The method of claim 42 further comprising forming the non-circular and non-rectangular cross sectional shapes in at least one of: an S shape, and a curved disk shape.
